(19) United States
(12) Patent Application Publication
(10) Pub. No.: US 2026/0327113 A1
(43) Pub. Date: Oct. 22, 2026

(54) METHOD FOR OPERATING BOILER

(71) Applicant: MIURA CO., LTD., Matsuyama-shi, Ehime (JP)

(72) Inventors: Takashi NINOMIYA, Matsuyama-shi (JP); Ai TOKUMI, Matsuyama-shi (JP); Takeshi NAKANO, Matsuyama-shi (JP); Yosuke KIKUCHI, Matsuyama-shi (JP); Shinji MATSUTOMO, Matsuyama-shi (JP)

(73) Assignee: MIURA CO., LTD., Matsuyama-shi, Ehime (JP)

(21) Appl. No.: 19/122,510

(22) PCT Filed: Sep. 19, 2023
(86) PCT No.: PCT/JP2023/033824

§ 371 Date: Apr. 18, 2025

(30) Foreign Application Priority Data
Oct. 20, 2022 (JP) 2022-168129

(51) Int. Cl. C02F 5/10; C02F 1/66; C02F 103/02; F22D 11/00

(52) U.S. Cl. CPC C02F 5/105; C02F 1/66; F22D 11/00; C02F 2103/02; C02F 2303/08

(57) ABSTRACT

Makeup water softened by a water softening device 16 and deoxygenated by a deoxygenating device 17 is stored in a water supply tank 11, and is supplied from the water supply tank 11 to a boiler 20 through a water supply passage 13. The boiler 20 stores water supplied from the water supply passage 13 as boiler water, and generates steam by heating the boiler water through a water pipe. At this time, a water treatment agent containing a pH-adjusting agent, sodium silicate, and sodium polyacrylate having a mass average molecular weight of 2,000 to 40,000 is added from a chemical supply device 40 to the feed water from the water supply passage 13 to the boiler 20 to control the pH of boiler water to an alkaline region, and sodium silicate and a polyacrylic acid-based compound having a mass average molecular weight within the above range are made to coexist in the boiler water.

### TECHNICAL FIELD

The present invention relates to a method for operating a boiler, particularly a method for operating a boiler that generates steam by heating boiler water. The present application claims priority based on Japanese Patent Application No. 2022-168129 filed in Japan on Oct. 20, 2022, the contents of which are incorporated herein by reference.

### BACKGROUND ART

A general boiler device for supplying steam to a load device such as a heat exchanger generates steam by heating feed water to a boiler as boiler water, and supplies the steam to the load device through a steam passage. Since the inside of the boiler is in a high-temperature and high-pressure environment, scale adheres or corrosion occurs due to the influence of various dissolved components in the feed water on a heat transfer surface of a water pipe that generates steam. The scale adhering to the heat transfer surface interferes with heat conduction and thus deteriorates operation efficiency of the boiler. Further, corrosion of the heat transfer surface damages the water pipe as the corrosion progresses, which causes inhibition of stable and continuous operation of the boiler.

In the operation of the boiler device, calcium ions and magnesium ions, which cause scale, are generally removed from the feed water to the boiler, while dissolved oxygen, which causes corrosion, is removed. A water treatment agent is added to the feed water to suppress scale generation and corrosion progress in the boiler.

As a water treatment agent to be added to the feed water, as described in Patent Literature 1 and 2, a water treatment agent in which a silicic acid-based compound such as silica or a silicate is used in combination with a scale inhibitor is already known. The silicic acid-based compound forms a film on the heat transfer surface, and suppresses corrosion by the film. The scale inhibitor is a chelating agent such as ethylenediaminetetraacetic acid or a water-soluble polymer such as a polyacrylic acid-based compound. The chelating agent chelates calcium ions and magnesium ions in the boiler water to suppress scale generation. On the other hand, the water-soluble polymer disperses scale substances derived from calcium ions and magnesium ions in the boiler water to suppress the growth of crystal nuclei of scale to suppress scale generation.

Corrosion occurring on the heat transfer surface of the boiler is known as overall corrosion that uniformly proceeds over the entire heat transfer surface and pitting corrosion that locally proceeds in a hole shape in a thickness direction of the heat transfer surface. In the overall corrosion, microscopic anode-cathode pairs are generated on the entire heat transfer surface, and the corrosion proceeds due to short-circuiting cells between these pairs. On the other hand, for the pitting corrosion, macroscopic anode and cathode are generated locally on the heat transfer surface, and the corrosion proceeds by the short-circuit battery. According to Patent Literature 1 and 2, the silicic acid-based compound used therein is effective in suppressing pitting corrosion, but cannot be expected to have an effect of suppressing overall corrosion.

### PRIOR ART LITERATURE

### Patent Literature

Patent Literature 1: JP-A-2002-18487
Patent Literature 2: JP-A-2003-160889

### DISCLOSURE OF THE INVENTION

### Problems to be Solved by the Invention

The present invention is intended to suppress generation of scale in a boiler and suppress corrosion of both overall corrosion and pitting corrosion in the boiler by using a silicic acid-based compound and a polyacrylic acid-based compound in combination.

### Solution to the Problems

The present invention relates to a method for operating a boiler that generates steam by heating boiler water. This operation method includes controlling the pH of the boiler water such that it is brought into an alkaline region; and allowing a polyacrylic acid-based compound having a mass average molecular weight of 2,000 to 40,000 to coexist in the boiler water in an environment where a silicic acid-based compound exists.

According to one aspect of the operation method of the present invention, the silicic acid-based compound is derived from a natural component contained in feed water to the boiler.

According to another aspect of the operation method of the present invention, a chemical containing a silicic acid-based compound and the polyacrylic acid-based compound is added to feed water to the boiler.

In the operation method according to this aspect, by adjusting an amount of the chemical supplied to the feed water and adjusting a concentration ratio of the boiler water, a pH of the boiler water is maintained in an alkaline region, and a silicic acid-based compound concentration and a polyacrylic acid-based compound concentration in the boiler water is controlled to be target concentrations of 100 to 600 mg/L in terms of a silicon dioxide equivalent concentration and 1 to 500 mg/L in terms of a salt equivalent concentration, respectively. Preferably, softened water is used as the feed water, and the silicic acid-based compound concentration and the polyacrylic acid-based compound concentration of the boiler water are each controlled to the target concentration when a ratio of an acid consumption (pH 4.8) to an electric conductivity of the feed water (acid consumption (pH 4.8)/electric conductivity) indicates a corrosion occurrence tendency of the boiler.

The present invention according to another aspect relates to a boiler water treatment agent. The boiler water treatment agent contains a silicic acid-based compound and a polyacrylic acid-based compound having a mass average molecular weight of 2,000 to 40,000.

The boiler water treatment agent according to the present invention has, for example, an amount ratio (Y/X) of a content (Y % by mass) of the polyacrylic acid-based compound in terms of salt to a content (X % by mass) of the silicic acid-based compound in terms of silicon dioxide, which is set to 0.001 to 500.

The boiler water treatment agent according to the present invention has preferably a total content of ethylenediaminetetraacetic acid and alkali metal salts thereof of less than 1% by mass.

### Effects of the Invention

In the method for operating a boiler according to the present invention, the pH of boiler water is maintained in an alkaline region, and a polyacrylic acid-based compound having a mass average molecular weight in a specific range coexists in an environment where a silicic acid-based compound exists, so that it is possible to suppress generation of scale in the boiler and to suppress corrosion of both overall corrosion and pitting corrosion in the boiler.

Since the boiler water treatment agent according to the present invention contains a silicic acid-based compound and a polyacrylic acid-based compound having a mass average molecular weight in a specific range, it is possible to suppress generation of scale in the boiler and to suppress corrosion of both the overall corrosion and pitting corrosion in the boiler by using the boiler water treatment agent in the method for operating a boiler according to the present invention.

### BRIEF DESCRIPTION OF THE DRAWINGS

FIG. 1 is a schematic view of one embodiment of a boiler device capable of implementing an operation method according to the present invention.

FIG. 2 is a graph illustrating the relationship between a mass average molecular weight of sodium polyacrylate and a maximum pitting depth in Experimental Examples 2 to 17 and 19 to 33, based on the results shown in Table 1.

FIG. 3 is a graph illustrating the relationship between a mass average molecular weight of sodium polyacrylate and a corrosion rate in Experimental Examples 2 to 17 and 19 to 33, based on the results shown in Table 1.

### DESCRIPTION OF PREFERRED EMBODIMENTS

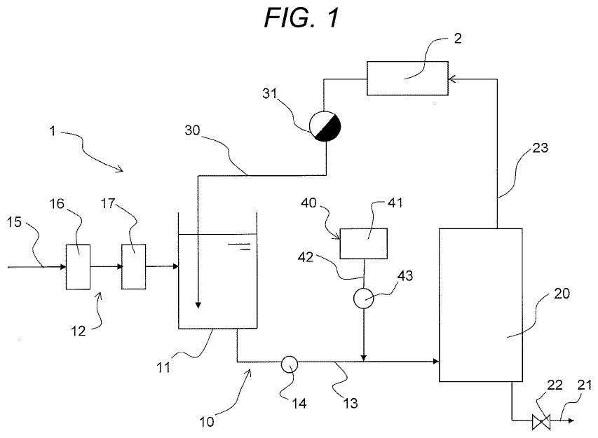

Referring to FIG. 1, a description will be given for one embodiment of a boiler device capable of implementing an operation method got operating a boiler according to the present invention. In FIG. 1, a boiler device 1 is for supplying steam to a load device 2 which is steam equipment such as a heat exchanger, a steam pot, a reboiler, or an autoclave, and mainly includes a water supply device 10, a boiler 20, a condensate pipe 30, and a chemical supply device 40.

The water supply device 10 is for supplying feed water used as boiler water in the boiler 20, and mainly includes a water supply tank 11 for storing the feed water, and a replenishment passage 12 for supplying makeup water used as the feed water to the water supply tank 11. The water supply tank 11 has a water supply passage 13 extending from the bottom of the water supply tank to the boiler 20. The water supply passage 13 communicates with the boiler 20, and includes a water supply pump 14 for delivering the feed water stored in the water supply tank 11 to the boiler 20.

The replenishment passage 12 includes a water injection path 15. The water injection path 15 is for supplying makeup water from a raw water tank (not shown) in which raw water supplied from a water source such as tap water, industrial water, or ground water is stored to the water supply tank 11, and includes a water softening device 16 and a deoxygenating device 17 in this order toward the water supply tank 11.

The water softening device 16 treats the makeup water from the raw water tank with a sodium cation exchange resin, and converts calcium ions and magnesium ions, which are hardness components contained in the makeup water, into softened water by replacing them with sodium ions.

The deoxygenating device 17 is for removing dissolved oxygen in the makeup water treated in the water softening device 16, and various types of deoxygenating devices such as a device in which dissolved oxygen is removed using a separation membrane, a device in which dissolved oxygen is removed from the treated water under a reduced pressure environment, and a device in which dissolved oxygen is removed by heating the treated water are used.

The boiler 20 includes therein a large number of standing water pipes (not illustrated), stores feed water from the water supply passage 13 as the boiler water in a bottom portion, and generates steam by heating the boiler water through a heat transfer surface of the water pipe. The water pipe is formed using a metal that does not passivate naturally in a neutral aqueous solution such as carbon steel, cast iron, copper, or a copper alloy. The boiler 20 has a blow passage 21 for discarding the boiler water, and the blow passage 21 has a control valve 22 for adjusting a disposal amount of the boiler water. A steam supply pipe 23 communicating with the load device 2 extends from an upper portion of the boiler 20.

The condensate pipe 30 extends from the load device 2 to the water supply tank 11, and includes a steam trap 31. The steam trap 31 is for separating steam and condensed water.

The chemical supply device 40 is for supplying a water treatment agent into water supplied from the water supply tank 11 to the boiler 20, and includes a chemical tank 41 for storing the water treatment agent, a supply path 42 extending from the chemical tank 41 to the water supply passage 13, and a supply pump 43 provided in the supply path 42. The supply pump 43 sends the water treatment agent stored in the chemical tank 41 to the water supply passage 13 through the supply path 42, and can control a supply amount of the water treatment agent.

The water treatment agent stored in the chemical tank 41 of the chemical supply device 40 contains a silicic acid-based compound and a polyacrylic acid-based compound, which is preferably an aqueous solution containing a silicic acid-based compound and a polyacrylic acid-based compound. The water used in this aqueous solution is usually purified water such as distilled water or ion-exchanged water.

The silicic acid-based compound contained in the water treatment agent is silicic acid or a silicate, and is a component for forming a film on the surfaces of the water pipe in the boiler 20 and suppressing corrosion of the water pipe. Silicic acid is a silicon compound represented by the chemical formula of [SiOₓ(OH)₄₋₂ₓ]ₙ, and is usually silicic anhydride (SiO₂), orthosilicic acid (H₄SiO₄), metasilicic acid (H₂SiO₃), or metadisilicic acid (H₂Si₂O₅). Additionally, the silicate is, for example, an orthosilicate represented by a chemical formula of nSiO₂·(n+1)M₂O or a hydrate thereof, or alternatively, a polysilicate represented by a chemical formula of nSiO₂·nM₂O, nSiO₂·(n−1)M₂O or nSiO₂·(n−2)M₂O or a hydrate thereof. In the chemical formula of the silicate, n is an integer larger than 2, and M represents a metal element such as an alkali metal such as sodium or potassium, or an alkaline earth metal such as calcium or magnesium. When the metal element is divalent, the number of molecules of M is halved. The water treatment agent may contain at least two silicic acid-based compounds.

The polyacrylic acid-based compound contained in the water treatment agent is a component for suppressing generation of scale in the boiler 20 and suppressing both overall corrosion and local corrosion of the water pipe in the boiler 20 by interaction with the silicic acid-based compound. As the polyacrylic acid-based compound, a water-soluble polymer compound containing a carboxyl group derived from at least one of acrylic acid and methacrylic acid or a salt thereof is usually used. For example, a copolymer or a terpolymer using at least one of polyacrylic acid, polymethacrylic acid, acrylic acid, and methacrylic acid as a monomer, or a salt thereof can be used. As the salt, for example, an alkali metal salt such as a sodium salt or a potassium salt is used. Preferred as the polyacrylic acid-based compound are polyacrylic acid and salts thereof. As the polyacrylic acid-based compound, a polyacrylic acid-based compound having a mass average molecular weight in a specific range that can exhibit an anticorrosion effect by interaction with the silicic acid-based compound, specifically, a polyacrylic acid-based compound having a mass average molecular weight of 2,000 to 40,000, preferably 3,000 to 20,000, more preferably 4,000 to 10,000 is selectively used. The water treatment agent may contain at least two polyacrylic acid-based compounds.

The water treatment agent may contain other components such as a pH adjuster and a deoxygenating agent in addition to the silicic acid-based compound and the polyacrylic acid-based compound. The pH adjuster suppresses corrosion in the boiler 20 by adjusting the pH of the boiler water to an alkaline region. For example, an alkali metal hydroxide such as sodium hydroxide or potassium hydroxide is used as the pH adjuster. At least two kinds of pH adjusters may be used in combination. The deoxygenating agent suppresses corrosion in the boiler 20 by removing dissolved oxygen in the boiler water. For example, ascorbic acid or a salt thereof, tannin, a saccharide-based deoxygenating agent, erythorbic acid or a salt thereof, or a sulfite is used as the deoxygenating agent. At least two kinds of deoxygenating agents may be used in combination.

A general water treatment agent for boiler water often contains ethylenediaminetetraacetic acid (EDTA) or an alkali metal salt thereof as a scale inhibitor. However, the ethylenediaminetetraacetic acid or the alkali metal salt may promote corrosion in the boiler 20. Therefore, the water treatment agent used in this embodiment is preferably one that does not substantially contain EDTA and an alkali metal salt thereof, for example, one in which the total content thereof is controlled to less than 1% by mass.

In the water treatment agent, the content of the silicic acid-based compound and the polyacrylic acid-based compound is set such that the amount ratio (Y/X) of the content (Y % by mass) of the polyacrylic acid-based compound in terms of salt to the content (X % by mass) of the silicic acid-based compound in terms of silicon dioxide is preferably 0.001 to 500, and more preferably 0.1 to 50, because the silicic acid-based compound concentration and the polyacrylic acid-based compound concentration in the boiler water can be easily controlled to target concentrations to be described later. The content of the polyacrylic acid-based compound in terms of salt is a content obtained by regarding the polyacrylic acid-based compound as a salt in which all carboxyl groups in the molecule form a sodium salt.

Next, a method for operating the boiler device 1 will be described.

In the operation of the steam boiler device 1, first, makeup water is supplied from the raw water tank (not shown) to the water supply tank 11 through the water injection path 15, and this makeup water is stored in the water supply tank 11 as boiler feed water.

At this time, the makeup water from the raw water tank is first treated in the water softening device 16, and becomes softened water by removing the hardness components. The makeup water that has become softened water in the water softening device 16 is then deoxygenated in the deoxygenating device 17. Accordingly, dissolved oxygen promoting corrosion of the water pipe in the steam boiler 20 is removed from the makeup water. As a result, the deoxygenated softened water is stored in the water supply tank 11 as feed water.

When the water supply pump 14 is operated while the makeup water is stored in the water supply tank 11, the feed water stored in the water supply tank 11 is supplied to the boiler 20 through the water supply passage 13. The feed water supplied to the boiler 20 is stored as boiler water, and the boiler water rises in the water pipe while being heated through the water pipe to become steam. The steam generated in the water pipe is supplied to the load device 2 through a steam supply pipe 23. As the steam is generated, the boiler water is concentrated.

The steam supplied to the load device 2 passes through the load device 2 and flows to the condensate pipe 30, where the latent heat is lost and a part thereof is changed to condensed water, and the steam and the condensed water are separated in the steam trap 31 to become high-temperature condensate. The condensate thus generated is recovered to the water supply tank 11 through the condensate pipe 30 and reused as feed water. At this time, since the feed water stored in the water supply tank 11 is heated by the high-temperature condensate, a heating load on the boiler 20 is reduced.

During the operation as described above, the boiler device 1 adjusts the control valve 22 to control the amount of the boiler water discarded from the blow passage 21, and controls the water supply pump 14 to adjust the amount of the feed water supplied from the water supply tank 11 to the boiler 20 to control the concentration ratio of the boiler water, thereby adjusting the acid consumption (pH 4.8) of the boiler water to maintain the pH of the boiler water in an alkaline region where corrosion is unlikely to occur, preferably the pH of the boiler water at 11 to 12.5.

The acid consumption (pH 4.8) is an amount of hydrogen ions (amount of acid) required to neutralize an alkali such as a hydrogen carbonate, a carbonate or a hydroxide dissolved in the feed water to a predetermined pH (here, 4.8), which is expressed in mg per liter of the feed water in terms of an amount of calcium carbonate corresponding to hydrogen ions (acid), and can be measured according to the method specified in JIS K 0101.

During the operation of the boiler device 1, the water treatment agent is appropriately supplied from the chemical supply device 40 to the feed water flown to the boiler 20 in the water supply passage 13. As a result, the polyacrylic acid-based compound having a mass average molecular weight in a specific range coexists with the silicic acid-based compound in the boiler water. Consequently, in the water pipes of the boiler 20, the polyacrylic acid-based compound suppresses the growth of the crystal nuclei of the scale to suppress the generation of the scale, and the silicic acid-based compound forms the anticorrosive film on the surface of the water pipe, and corrosion, particularly, both the overall corrosion and local corrosion are suppressed by the interaction between the silicic acid-based compound and the polyacrylic acid-based compound.

From the viewpoint of enhancing the scale suppression effect and the anticorrosion effect of both the overall corrosion and local corrosion, it is preferable that the boiler water is controlled such that the amount of the water treatment agent supplied from the chemical supply device 40 to the feed water is adjusted by the control of the supply pump 43 and a concentration ratio is adjusted by the method described above, whereby the pH is maintained in an alkaline region, particularly 11 to 12.5, and the silicic acid-based compound concentration and the concentration of the polyacrylic acid-based compound having a mass average molecular weight are in specific ranges are controlled to a predetermined target concentration. Specifically, it is preferable that the silicic acid-based compound concentration is controlled to 100 to 600 mg/L, particularly 200 to 500 mg/L as a concentration in terms of silicon dioxide (SiO₂), and the concentration of the polyacrylic acid-based compound having a mass average molecular weight in a specific range is controlled to 1 to 500 mg/L, particularly 10 to 200 mg/L as a salt equivalent concentration. The salt equivalent concentration is a concentration obtained by regarding the polyacrylic acid-based compound as a salt in which all carboxyl groups in the molecule form a sodium salt.

The water treatment agent is preferably added to the feed water when the water quality of the feed water supplied from the water supply tank 11 to the boiler 20 tends to cause corrosion of the water pipe in the boiler 20. This tendency can be evaluated, for example, according to the water quality determination method described in Japanese Patent No. 4033667. Specifically, an acid consumption (pH 4.8) and an electric conductivity of the feed water supplied from the water supply tank 11 to the boiler 20 through the water supply passage 13 are continuously measured, and an index expressed by the following equation (1) is obtained. When this index is 2.5 or more, it can be determined that the feed water has water quality that hardly corrodes the water pipe. On the other hand, when the index is less than 2.5, it can be determined that the feed water has water quality that tends to corrode the water pipe, particularly tends to cause pitting corrosion, which is local corrosion, in the water pipe. Therefore, during the operation of the boiler device 1, when the index is less than 2.5, the water treatment agent is preferably supplied from the chemical supply device 40 to the feed water, and the silicic acid-based compound concentration in the boiler water and the concentration of the polyacrylic acid-based compound having a mass average molecular weight in specific ranges are preferably controlled to the target concentrations described above.

$$\begin{matrix}[ Math . 1 ] & \\ Index = \frac{Acid consumption ( pH 4.8 ) ( {mgCaCO}_{3} / L )}{Electric conductivity ( mS / m )} & ( 1 )\end{matrix}$$

The acid consumption (pH4.8) is as described above. Further, the electric conductivity corresponds to the reciprocal of the electrical resistivity (Ω·m) of the feed water at 25° C., and is expressed in units of mS/m (millisiemens per meter), and can be measured according to the method specified in JIS K 0101 as with the acid consumption (pH 4.8).

In the embodiment described above, the water treatment agent containing the silicic acid-based compound is used. However, when the feed water supplied to the boiler 20 contains a large amount of the silicic acid-based compound derived from the raw water, and the concentration of silicon dioxide in the boiler water can be easily increased by increasing the concentration ratio of the boiler water, a water treatment agent containing a reduced content of the silicic acid-based compound or a water treatment agent not containing the silicic acid-based compound can also be used.

### Experimental Example

The boiler device 1 according to the embodiment stated above was operated to examine the progress of corrosion on the heat transfer surface of the water pipe (made of STPG (carbon steel pipe for pressure piping) described in JIS G 3454) of the boiler 20. Since both chloride ions and sulfate ions have a relatively high concentration, test water imitating clean water near Osaka, which is considered to have highly corrosive water quality, was supplied from the water injection path 15 to the water supply tank 11 to be stored, and supplied from the water supply tank 11 to the boiler 20 through the water supply passage 13. The water quality of the test water is as follows.

### (Test Water Quality)

pH: 7.5
Electric conductivity: 25 mS/m
Acid consumption (pH4.8): 20 mg CaCO₃/L
Silicon dioxide concentration: 7 mg SiO₂/L

In this experimental example, the chemical supply device 40 was disposed with respect to the water supply passage 13, and the water treatment agent described later was appropriately added to the feed water. The operating conditions of the boiler 20 were set such that the operating pressure and the concentration ratio were 0.3 MPa and 10 times, respectively.

In the operation of the boiler device 1, the dissolved oxygen concentration of the feed water supplied from the water supply tank 11 to the boiler 20 was adjusted to 4.0 mg/L by treating the test water in the deoxygenating device 17. Further, by appropriately adding the water treatment agent from the chemical supply device 40 to the feed water to the boiler 20 and adjusting the waste amount of the boiler water by the control of the control valve 22, the concentration ratio of the boiler water in the boiler 20 was controlled to be 10-fold, and the water quality of the boiler water was controlled as shown in Table 1. In the water treatment chemical added in each experimental example, the concentrations of sodium hydroxide, sodium silicate, and sodium polyacrylate were appropriately adjusted so that the water quality of the boiler water was as shown in Table 1. For example, when the pH of the boiler water was not sufficiently increased only by the pH increase accompanying the decomposition of the acid consumption (pH 4.8), the concentration of sodium hydroxide in the water treatment chemical was adjusted to be increased. In Table 1, the silicon dioxide concentration of Experimental Examples 1 to 17 was obtained by 10-fold concentration of the test water having a silicon dioxide concentration of 7 mg SiO₂/L in the boiler.

The operation of the boiler 20 was stopped 48 hours after the start of the operation, a water pipe for evaluation was extracted from the boiler 20, and the progress of corrosion on the surface of the water pipe was evaluated for both local corrosion and overall corrosion. In this evaluation, the depth of each pitting corrosion generated on the heat transfer surface was examined for local corrosion, and the maximum depth was obtained. The larger the maximum depth is, the more pitting corrosion progresses. For the overall corrosion, a corrosion rate represented by mdd (mg/dm²/day) was determined. mdd represents a mass reduction amount (mg) of the water pipe basis material per day in a unit surface area (1 dm²) of the contact surface with water, and as mdd is larger, a corrosion rate is higher, and overall corrosion is progressing.

The evaluation results are shown in Table 1. The evaluation results shown in Table 1 are relative values when the results of the maximum pitting depth (μm) and the corrosion rate (mdd) in Experimental Example 1 are taken as 100% values. When the relative value is suppressed to less than 50% in a case where the boiler 20 is operated using the test water imitating clean water near Osaka, it can be evaluated that corrosion is practically sufficiently suppressed in view of the applicant's rule of thumb.

### [Table 1]

TABLE 1

| | Boiler water quality | | | | Corrosion evaluation | |
|---|---|---|---|---|---|---|
| | | Sodium polyacrylate | | | (relative value) | |
| | | Mass average | | Concentration | Maximum | |
| Experimental | | molecular | Concentration | of silicon | pitting | Corrosion |
| Example | pH | weight (Mw) | (mg/L) | dioxide (mg/L) | depth (%) | rate (%) |
| 1 | 11.0 | — | 0 | 70 | 100 | 100 |
| 2 | 11.0 | 2,000 | 60 | 70 | 73 | 103 |
| 3 | 11.0 | 2,000 | 120 | 70 | 56 | 73 |
| 4 | 11.0 | 3,250 | 60 | 70 | 69 | 75 |
| 5 | 11.0 | 3,250 | 120 | 70 | 51 | 89 |
| 6 | 11.0 | 5,250 | 60 | 70 | 117 | 76 |
| 7 | 11.0 | 5,250 | 120 | 70 | 56 | 59 |
| 8 | 11.0 | 8,000 | 60 | 70 | 54 | 75 |
| 9 | 11.0 | 8,000 | 120 | 70 | 55 | 72 |
| 10 | 11.0 | 13,500 | 60 | 70 | 91 | 77 |
| 11 | 11.0 | 13,500 | 120 | 70 | 65 | 71 |
| 12 | 11.0 | 20,000 | 60 | 70 | 97 | 81 |
| 13 | 11.0 | 20,000 | 120 | 70 | 64 | 89 |
| 14 | 11.0 | 60,000 | 120 | 70 | 65 | 102 |
| 15 | 11.0 | 100,000 | 60 | 70 | 66 | 76 |
| 16 | 11.0 | 100,000 | 120 | 70 | 72 | 93 |
| 17 | 11.0 | 250,000 | 120 | 70 | 66 | 67 |
| 18 | 11.0 | — | 0 | 356 | 61 | 46 |
| 19 | 11.0 | 2,000 | 60 | 356 | 52 | 30 |
| 20 | 11.0 | 2,000 | 120 | 356 | 61 | 20 |
| 21 | 11.0 | 3,250 | 120 | 356 | 45 | 22 |
| 22 | 11.0 | 5,250 | 60 | 356 | 47 | 23 |
| 23 | 11.0 | 5,250 | 120 | 356 | 49 | 31 |
| 24 | 11.0 | 8,000 | 60 | 356 | 42 | 32 |
| 25 | 11.0 | 8,000 | 120 | 356 | 39 | 30 |
| 26 | 11.0 | 13,500 | 60 | 356 | 43 | 41 |
| 27 | 11.0 | 13,500 | 120 | 356 | 44 | 33 |
| 28 | 11.0 | 20,000 | 60 | 356 | 40 | 38 |
| 29 | 11.0 | 20,000 | 120 | 356 | 43 | 34 |
| 30 | 11.0 | 60,000 | 120 | 356 | 38 | 56 |
| 31 | 11.0 | 100,000 | 60 | 356 | 45 | 51 |
| 32 | 11.0 | 100,000 | 120 | 356 | 33 | 52 |
| 33 | 11.0 | 250,000 | 120 | 356 | 34 | 84 |

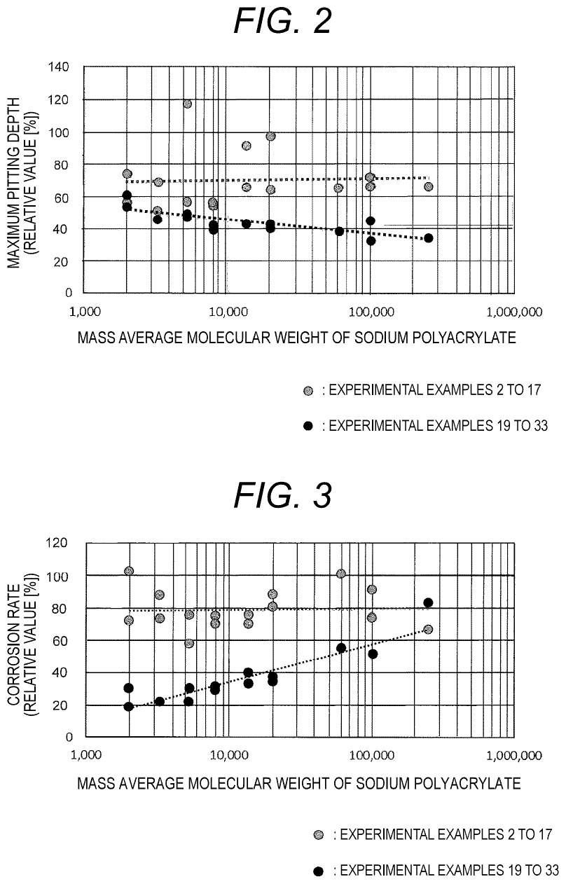

The results of Table 1 are graphed in FIGS. 2 and 3. According to FIG. 2, in Experimental Examples 19 to 33 in which the concentration of silicon dioxide in the boiler water was increased by addition of sodium silicate, a correlation between the mass average molecular weight of sodium polyacrylate and the maximum pitting depth is recognized. Specifically, it is recognized that the maximum pitting depth tends to decrease as the mass average molecular weight of sodium polyacrylate increases. Further, according to FIG. 3, in Experimental Examples 19 to 33 in which the concentration of silicon dioxide in the boiler water was increased by addition of sodium silicate, a correlation between the mass average molecular weight of sodium polyacrylate and the corrosion rate is also recognized. Specifically, it is recognized that the corrosion rate tends to decrease as the mass average molecular weight of sodium polyacrylate decreases. In view of the results of FIGS. 2 and 3, it can be seen that in the boiler water, when the silicon dioxide concentration is increased by the addition of sodium silicate and sodium polyacrylate having a mass average molecular weight in the range of about 2,000 to 40,000 coexists, the progress of both pitting corrosion and overall corrosion is easily suppressed.

Furthermore, according to FIGS. 2 and 3, when the concentration of silicon dioxide in the boiler water is increased, the maximum pitting depth and the corrosion rate can be controlled by selecting the mass average molecular weight of sodium polyacrylate to coexist in view of the correlation described above, and thus there is a possibility that fine corrosion management for the water pipe can be implemented.

1. A method for operating a boiler that generates steam by heating boiler water, the method comprising:
controlling a pH of the boiler water to an alkaline region; and
allowing a polyacrylic acid-based compound having a mass average molecular weight of 2,000 to 40,000 to coexist in the boiler water in an environment where a silicic acid-based compound exists.

2. The method for operating a boiler according to claim 1, wherein the silicic acid-based compound is derived from a natural component contained in feed water to the boiler.

3. The method for operating a boiler according to claim 1, wherein a chemical containing a silicic acid-based compound and the polyacrylic acid-based compound is added to feed water to the boiler.

4. The method for operating a boiler according to claim 3, wherein by adjusting an amount of the chemical supplied to the feed water and adjusting a concentration ratio of the boiler water, a pH of the boiler water is maintained in an alkaline region, and a silicic acid-based compound concentration and a polyacrylic acid-based compound concentration in the boiler water are controlled to target concentrations of 100 to 600 mg/L in terms of a silicon dioxide equivalent concentration and 1 to 500 mg/L in terms of a salt equivalent concentration, respectively.

5. The method for operating a boiler according to claim 4, wherein softened water is used as the feed water, and the silicic acid-based compound concentration and the polyacrylic acid-based compound concentration of the boiler water are each controlled to the target concentration when a ratio of an acid consumption (pH 4.8) to an electric conductivity of the feed water (acid consumption (pH 4.8)/electric conductivity) indicates a corrosion occurrence tendency of the boiler.

6. A boiler water treatment agent, comprising:
a silicic acid-based compound; and
a polyacrylic acid-based compound having a mass average molecular weight of 2,000 to 40,000.

7. The boiler water treatment agent according to claim 6, wherein an amount ratio (Y/X) of a content (Y % by mass) of the polyacrylic acid-based compound in terms of salt to a content (X % by mass) of the silicic acid-based compound in terms of silicon dioxide is set to 0.001 to 500.

8. The boiler water treatment agent according to claim 6, wherein a total content of ethylenediaminetetraacetic acid and an alkali metal salt thereof is less than 1% by mass.

9. The boiler water treatment agent according to claim 7, wherein a total content of ethylenediaminetetraacetic acid and an alkali metal salt thereof is less than 1% by mass.
